(19) United States
(12) Patent Application Publication
(10) Pub. No.: US 2015/0178188 A1
(43) Pub. Date: Jun. 25, 2015

(54) Storage Module and Method for Re-Enabling Preloading of Data in the Storage Module

(71) Applicant: SanDisk Technologies Inc., Plano, TX (US)

(72) Inventors: Lola Grin, Netanya (IL); Itshak Afriat, Tel-Mond (IL); Einat Lev, Kfar saba (IL); Idit Gabbay, Akko (IL); Rotem Sela, Haifa (IL)

(73) Assignee: SanDisk Technologies Inc., Plano, TX (US)

(21) Appl. No.: 14/137,367

(22) Filed: Dec. 20, 2013

(51) Int. Cl. G06F 12/02

(52) U.S. Cl. CPC G06F 12/0246; G06F 2212/7207

(57) ABSTRACT

A storage module and method for re-enabling preloading of data in the storage module are disclosed. In one embodiment, a storage module is provided with a memory and a register. In response to receiving a register-setting command, the storage module sets a value in the register to enable preloading of data in the memory. The storage module then receives the data for storage in the memory. After the storage module has determined that all of the data has been received, the storage module changes the value in the register to disable further preloading of data. In response to receiving a register-resetting command, the storage module resets the value in the register to re-enable preloading of data even though the storage module already changed the value in the register to disable further preloading of data.

### BACKGROUND

A storage module can be embedded in a host device, such as a smart phone, by physically soldering the storage module onto a printed circuit board of the host device. Before the soldering occurs, the storage module is preloaded with data (e.g., an operating system, a GPS map, etc.), and the embedded MultiMediaCard (eMMC) 5.0 standard describes a process for preloading data into a storage module. According to the standard, a production station writes the value of 1 into a production-enablement register in the storage module to enable the preloading of data. When the preloading of data is completed, the production-enablement register is cleared. The standard specifies various ways in which the production-enablement register can be cleared. In one way, known as the “auto mode,” the host informs the storage module of the size of the preloaded data. The storage module can contain a counter to track how much data is received by the host, and when the counter reaches the expected size, firmware in the storage module knows that it has received all of the preloaded data and clears the production-enablement register.

Once the production-enablement register is cleared, it cannot be set to 1 again, meaning that data can only be preloaded into the storage module once. This can present a problem in certain situations. For example, if the production-enablement register is cleared before it has verified that the preloaded data was written correctly in the memory, the preloaded data cannot be re-written—even if an error is identified. As another example, a vendor may want to preload another image at a later time into the storage module. Again, this cannot be done after the production-enablement register has been cleared. In each of these situations, the storage module may need to be discarded.

### Overview

Embodiments of the present invention are defined by the claims, and nothing in this section should be taken as a limitation on those claims.

By way of introduction, the below embodiments relate to a storage module and method for re-enabling preloading of data in the storage module. In one embodiment, a storage module is provided with a memory and a register. In response to receiving a register-setting command, the storage module sets a value in the register to enable preloading of data in the memory. The storage module then receives the data for storage in the memory. After the storage module has determined that all of the data has been received, the storage module changes the value in the register to disable further preloading of data. In response to receiving a register-resetting command, the storage module resets the value in the register to re-enable preloading of data even though the storage module already changed the value in the register to disable further preloading of data.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary storage module of an embodiment.

FIG. 2A is a block diagram of a host of an embodiment, where the exemplary storage module of FIG. 1 is embedded in the host.

FIG. 2B is a block diagram of the exemplary storage module of FIG. 1 removably connected to a host, where the storage module and host are separable, removable devices

FIG. 3 is a flow chart of a method of an embodiment for re-enabling preloading of data in a storage module.

FIGS. 4A, 4B, and 4C are illustration of process flows of production stations of an embodiment.

### DETAILED DESCRIPTION OF THE PRESENTLY PREFERRED EMBODIMENTS

As mentioned above, in certain standards, such as the embedded MultiMediaCard (eMMC) 5.0 standard, preloaded data cannot be re-written into a storage module after a production-enablement register in the storage module has been cleared—even if there was a problem with the data or if the vendor wants to preload another image to the storage module. These embodiments provide a technique to re-enable preloading of data in the storage module. Before these embodiments are discussed, the following paragraphs provide a discussion of an exemplary storage module and host device that can be used with these embodiments. Of course, these are just examples, and other suitable types of storage modules and host devices can be used.

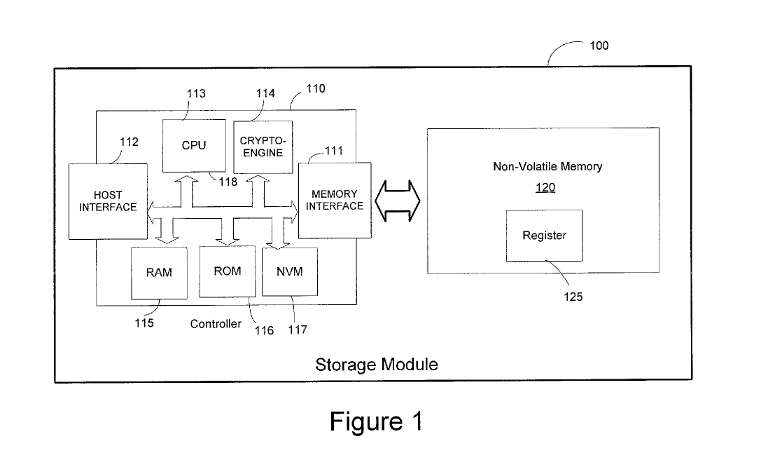

As illustrated in FIG. 1, a storage module 100 of one embodiment comprises a controller 110 and non-volatile memory 120. The controller 110 comprises a memory interface 111 for interfacing with the non-volatile memory 120 and a host interface 112 for placing the storage module 100 operatively in communication with a host controller. As used herein, the phrase “operatively in communication with” could mean directly in communication with or indirectly in communication with through one or more components, which may or may not be shown or described herein.

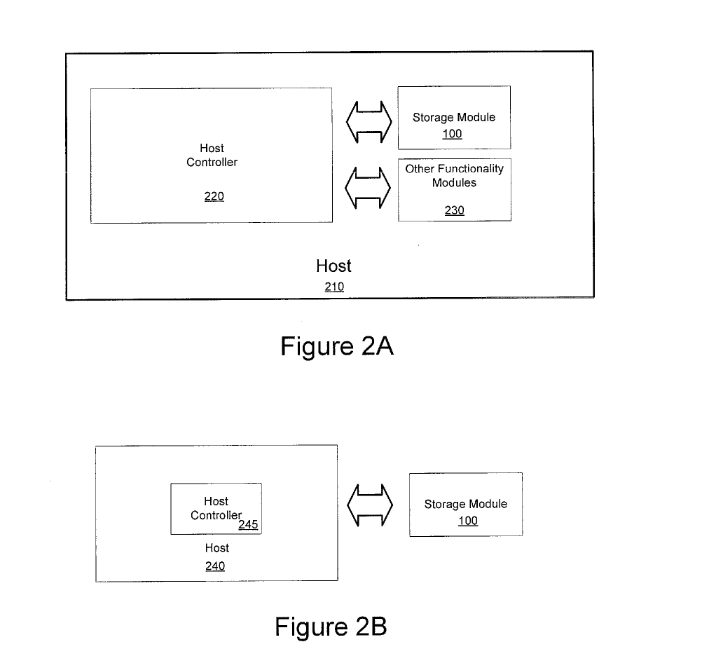

As shown in FIG. 2A, the storage module 100 can be embedded in a host 210 having a host controller 220. That is, the host 210 embodies the host controller 220 and the storage module 100, such that the host controller 220 interfaces with the embedded storage module 100 to manage its operations. For example, the storage module 100 can take the form of an iNAND™ eSD/eMMC embedded flash drive by SanDisk Corporation. The host controller 220 can interface with the embedded storage module 100 using, for example, an eMMC host interface or a UFS interface. The host 210 can take any form, such as, but not limited to, a solid state drive (SSD), a hybrid storage device (having both a hard disk drive and a solid state drive), a memory caching system, a mobile phone, a tablet computer, a digital media player, a game device, a personal digital assistant (PDA), a mobile (e.g., notebook, laptop) personal computer (PC), or a book reader. As shown in FIG. 2A, the host 210 can include optional other functionality modules 230. For example, if the host 210 is a mobile phone, the other functionality modules 230 can include hardware and/or software components to make and place telephone calls. As another example, if the host 210 has network connectivity capabilities, the other functionality modules 230 can include a network interface. Of course, these are just some examples, and other implementations can be used. Also, the host 210 can include other components (e.g., an audio output, input-output ports, etc.) that are not shown in FIG. 2A to simplify the drawing.

As shown in FIG. 2B, instead of being an embedded device in a host, the storage module 100 can have physical and electrical connectors that allow the storage module 100 to be removably connected to a host 240 (having a host controller 245) via mating connectors. As such, the storage module 100 is a separate device from (and is not embedded in) the host 240. In this example, the storage module 100 can be a handheld, removable memory device, such as a Secure Digital (SD) memory card, a microSD memory card, a Compact Flash (CF) memory card, or a universal serial bus (USB) device (with a USB interface to the host), and the host 240 is a separate device, such as a mobile phone, a tablet computer, a digital media player, a game device, a personal digital assistant (PDA), a mobile (e.g., notebook, laptop) personal computer (PC), or a book reader, for example.

In FIGS. 2A and 2B, the storage module 100 is in communication with a host controller 220 or host 240 via the host interface 112 shown in FIG. 1. The host interface 112 can take any suitable form, such as, but not limited to, an eMMC host interface, a UFS interface, and a USB interface. The host interface 110 in the storage module 100 conveys memory management commands from the host controller 220 (FIG. 2A) or host 240 (FIG. 2B) to the controller 110, and also conveys memory responses from the controller 110 to the host controller 220 (FIG. 2A) or host 240 (FIG. 2B). Also, it should be noted that when the storage module 100 is embedded in the host 210, some or all of the functions described herein as being performed by the controller 110 in the storage module 100 can instead be performed by the host controller 220.

The below embodiments discuss the storage module or host device being configured to perform certain functions. It should be understood that such configuring can be done by programming the controllers of the storage module and host device to perform these functions.

Returning to FIG. 1, the controller 110 comprises a central processing unit (CPU) 113, an optional hardware crypto-engine 114 operative to provide encryption and/or decryption operations, read access memory (RAM) 215, read only memory (ROM) 116 which can store firmware for the basic operations of the storage module 100, and a non-volatile memory (NVM) 117 which can store a device-specific key used for encryption/decryption operations, when used. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Suitable controllers can be obtained from SanDisk or other vendors. Also, some of the components shown as being internal to the controller 110 can also be stored external to the controller 110, and other component can be used. For example, the RAM 115 (or an additional RAM unit) can be located outside of the controller die and used as a page buffer for data read from and/or to be written to the memory 120.

The non-volatile memory 120 can also take any suitable form. For example, in one embodiment, the non-volatile memory 120 takes the form of a solid-state (e.g., flash) memory and can be one-time programmable, few-time programmable, or many-time programmable. The non-volatile memory 120 can also use single-level cells (SLC) or multi-level cell (MLC). The non-volatile memory 120 can take the form of NAND Flash memory or of other memory technologies, now known or later developed. The non-volatile memory 120 can be used to store user or other data. FIG. 1 also shows the non-volatile memory 120 storing a register 125, which will be discussed in more detail below. However, instead of being located in the non-volatile memory 120, the register 125 can be located in another location in the storage module 100, such as in the controller 110 (e.g., in the ROM 116 or NVM 117). In one embodiment, the register 125 is in the memory 120, and the value in the register 125 is read from the memory 120 and loaded to RAM 215 after a power cycle.

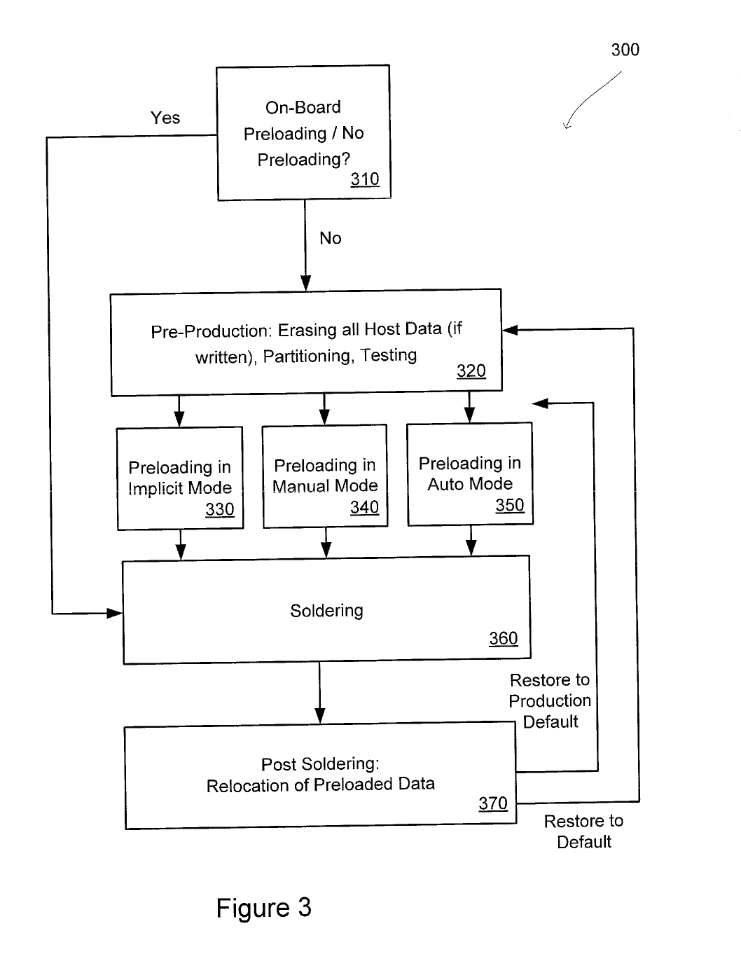

Returning to the drawings, FIG. 3 is a flow chart 300 of a method of an embodiment for re-enabling preloading of data in the storage module 100. As discussed above, the storage module 100 can be embedded in a host device, such as a smart phone, by physically soldering the storage module 100 onto a printed circuit board of the host device. Before the soldering occurs, a production station can preload the storage module 100 with data, such as an operating system or a GPS map, for example. A production station, which will sometimes be referred to herein as a host, can be a computer or other electronic device and typically has a memory storing the data to be preloaded into the storage module 100 and a controller/processor configured to store the data in the storage module 100. Such preloading before soldering is optional, so the first act in the flow chart 300 in FIG. 3 is to determine whether data will be preloaded in the storage module 100 before soldering or whether the data will be preloaded into the storage module 100 after soldering (“on-board preloading”) (act 310).

If there is no preloading or if there is on-board preloading, the method jumps to the soldering stage 360. However, if there is preloading, then an optional pre-production act can take place (act 320). In this pre-production act, user partitions are established, and the host can test write and read data in the device. Before the preloading stage, all written data for testing purposes can be erased, to ensure the memory 120 is clean before preloading. After this optional pre-production phase, the data is preloaded into the memory 120 of the storage device. In one embodiment, the memory cells in the memory 120 can be used either as single-level cells (SLCs) storing one bit per cell or multi-level cells (MLCs) storing more than one bit per cell. Some of the MLC cells can temporarily be used as SLC cells to receive the pre-loaded data, as data stored in SLC cells are less susceptible to uncorrectable errors caused by the soldering process than are MLC cells. After the soldering phase (act 360), the preloaded data is move from the SLC cells to the MLC cells, and the SLC cells are re-provisioned to MLC cells to return the capacity of the memory 120 to its exported device capacity (act 370).

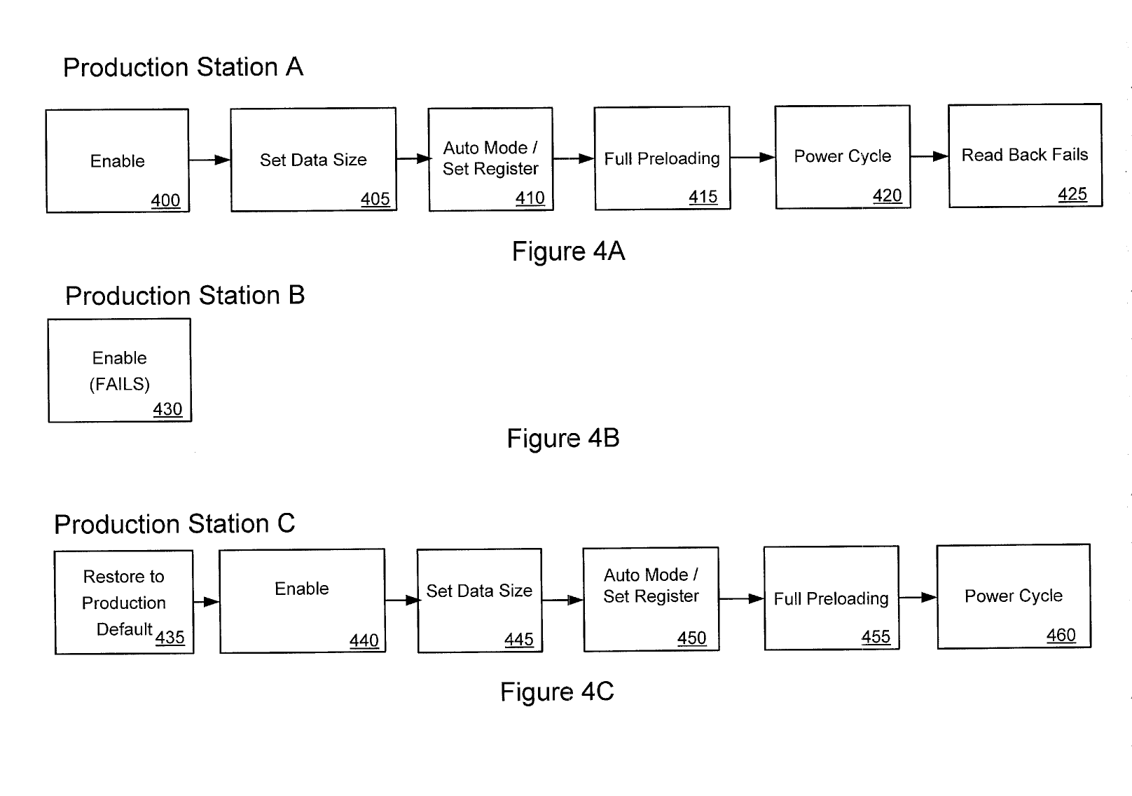

As discussed above, standards have been established that describe the process of preloading data into a storage module. For example, according to the embedded MultiMediaCard (eMMC) 5.0 standard, the production station needs to write the value of 1 into the production-enablement register 125 in the storage module 100 in order to have the storage module 100 enter the production mode and preload data. The eMMC 5.0 standard describes several production awareness flows, and one of these production awareness flows is known as the auto mode (act 350). The auto mode act 350 will be discussed with reference to FIG. 4A.

In the auto mode, the production station enables the preloading of data (act 400) and informs the storage module 100 of the size of preloaded data (act 405). The production station then sends a command to the storage module 100 to set a value in the production-enablement 125 (act 410) and begins to preload data in the storage module 100 (act 415). In the auto mode, the storage module's controller 110 contains a software counter to track how much data is received by the host. (The storage module 100 can commit the received data to memory 120 as it is being received or after all the data has been received.) When the counter reaches the expected size, the controller 110 knows that the storage module 100 has received all of the preloaded data that is it expecting and clears the production-enablement register 125. The storage module 100 can then go through a power cycle, as specified by the standard (act 420).

The eMMC 5.0 standard specifies that once the production-enablement register 125 is cleared, it cannot be set to 1 again. This means that once the storage module 100 detects that all the data has been received and clears the production-enablement register 125, data cannot be preloaded again in the memory 120. This can present a problem in certain situations. For example, a “read-back test after preloading” operation may determine that the preloaded data was not written correctly in the memory 120 (act 425). This can be due to an over-cycled production station, for example. As illustrated in act 430 in FIG. 4B, the storage module 100 cannot be moved to another production station and reprogrammed because the production-enablement register 125 has been cleared. As another example, a vendor may want to preload another image to the storage module 100 (e.g., changing the interface language before sending the device to another country, changing the operating system, changing a GPS map, etc.). Again, this cannot be done after the production-enablement register 125 has been cleared. In each of these situations, the storage module 100 may need to be discarded.

To overcome this problem, the production station can send a command to the storage module 100 to cause the storage module to reset the value in the register 125 to re-enable preloading of data even though the storage module 100 already changed the value in the register 125 to disable further preloading of data. This command is referred to in FIG. 3 either as “restore to production default” or “restore to default,” depending on whether or not the existing partitions are to be erased along with the previously preloaded data. The command would typically be sent before the storage module 100 is soldered to the host, such as when a write error is detected when preloading the storage module 100. As shown in FIG. 4C, with such a command given (act 435), the same or different production station can re-perform the preloading acts (acts 440-460), thereby overcoming the problem discussed above. In one embodiment, receipt of this command causes the storage module 100 to erase all programmed data until now and reset the register 125 of preloading enablement

The command to reset the value in the register 125 can take any suitable form. Where the storage module 100 operates under a standard that specifies that the value in the register 125 can only be set once to enable preloading of data, the command can be a vendor-specific command to perform an operation not specified in the standard. For example, in the eMMC 5.0 standard, the “Restore to Production Default” command is implemented as a vendor-specific command (CMD62), which allows hosts to perform out-of-spec operations. These operations are typically password-protected and, therefore, require the production station/host to enter the correct password before executing the command. Preferably, the password is only known by the manufacturer to prevent the preloaded data from being changed in the field by an unauthorized entity. In operation, the production station/host enters the configuration mode by ending CMD 62 with the appropriate op-code and exits it the same way. In-between, the production station/host can issue CMD62 along with the op-codes of the desired operations, like partition resize, restore to default, etc. CMD62 with the op-code of RTD (restore to default) enables the production station/host to reset the storage module 100 to factory configuration. This typically involves clearing the RPMB key and counter, restoring the production awareness state, logically erasing all data, and resetting EXT_CSD/CSD/CID to factory defaults (e.g., deleting GPPs/EUDA partitions, clearing WP, etc.). Thus, CMD62 with the op-code of RTD for the production-enablement register 125 (Production Awareness State) logically erases all host data from the storage module 100 and enables the production station/host to reset the production-enablement register 125, which allows restarting the preloading of data again. Accordingly, if storage module 100 fails during Read-Back test after preloading, a vendor-specific command (e.g., a “Restore to Default” command) can be sent to the storage module 100 (from the same or different production station) to restore the ability of storage module 100 to preload data.

As noted above, the eMMC 5.0 standard describes other modes, in addition to the auto mode, to enabling preloading of data in the storage module 100. For example, in the “manual mode” (act 340 in FIG. 3), the production station that provides the preloaded data (or another host device)—not the storage module 100—clears the production-enablement register. Accordingly, the production station can wait until it verifies that the preloaded data has been written correctly (e.g., after a “read-back test after preloading” operation is performed) and/or that the vendor is satisfied that he does not want to preload a different image before resetting the production-enablement register 125. Accordingly, “manual mode” does not encounter the problem discussed above.

Other modes of operation that are not defined in the specification can also be used, such as the “implicit mode.” Like in the auto mode, the storage module 100 in the implicit mode automatically clears the production-enablement register after a certain amount of data has been received from the production station. However, unlike the auto mode, the threshold amount of data is not set by the production station but rather by the size allocated in the storage module 100 for the preloaded data. If the size of the preloaded data is less that the size allocated for the preloaded data the production-enablement register 125 is cleared by the production station, as in the manual mode with an additional vendor specific command. Accordingly, “implicit mode” may or may not encounter the problem discussed above.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for re-enabling preloading of data in a storage module, the method comprising:
performing the following in a storage module comprising a memory and a register:
in response to receiving a command to set a value in the register, setting the value in the register to enable preloading of data in the memory;
receiving the data for storage in the memory;
determining that all of the data has been received;
after determining that all of the data has been received, changing the value in the register to disable further preloading of data; and
in response to receiving a command to reset the value in the register, resetting the value in the register to re-enable preloading of data even though the storage module already changed the value in the register to disable further preloading of data.

2. The method of claim 1, wherein the storage module operates under a standard that specifies that the value in the register can only be set once to enable preloading of data, and wherein the command to reset the value in the register is a vendor-specific command to perform an operation not specified in the standard.

3. The method of claim 2, wherein the standard is the embedded MultiMediaCard (eMMC) standard.

4. The method of claim 1, wherein the storage module operates in an auto mode.

5. The method of claim 1, wherein the storage module operates in an implicit mode.

6. The method of claim 1, wherein the command to reset the value in the register is received before the storage module is soldered to a host device.

7. The method of claim 1 further comprising:
in response to receiving the command to reset the value in the register, erasing data that was previously preloaded in the storage module.

8. The method of claim 7, wherein the data is erased without erasing existing partitions in the storage module.

9. The method of claim 7, the storage module erases the data and existing partitions in response to receiving the command to reset the value in the register.

10. The method of claim 1, wherein the command to reset the value in the register can only be sent to the storage module after a correct password is provided.

11. The method of claim 1, wherein the register is in the memory.

12. The method of claim 11, wherein the value in the register is read from the memory and loaded to random access memory after a power cycle.

13. The method of claim 1, wherein the data is stored in single-level cells in the memory, and wherein the method further comprises moving the data from the single-level cells in the memory to multi-level cells in the memory after the storage module has been soldered to a host device.

14. A storage module comprising:
a memory;
a register; and
a controller configured to:
in response to receiving a command to set a value in the register, set the value in the register to enable preloading of data in the memory;
receive the data for storage in the memory;
determine that all of the data has been received;
after determining that all of the data has been received, change the value in the register to disable further preloading of data; and
in response to receiving a command to reset the value in the register, reset the value in the register to re-enable preloading of data even though the storage module already changed the value in the register to disable further preloading of data.

15. The storage module of claim 14, wherein the storage module operates under a standard that specifies that the value in the register can only be set once to enable preloading of data, and wherein the command to reset the value in the register is a vendor-specific command to perform an operation not specified in the standard.

16. The storage module of claim 15, wherein the standard is the embedded MultiMediaCard (eMMC) standard.

17. The storage module of claim 14, wherein the storage module operates in an auto mode.

18. The storage module of claim 14, wherein the storage module operates in an implicit mode.

19. The storage module of claim 14, wherein the command to reset the value in the register is received before the storage module is soldered to a host device.

20. The storage module of claim 14, wherein the controller is further operative to:
in response to receiving the command to reset the value in the register, erase data that was previously preloaded in the storage module.

21. The storage module of claim 20, wherein the data is erased without erasing existing partitions in the storage module.

22. The storage module of claim 20, the storage module erases the data and existing partitions in response to receiving the command to reset the value in the register.

23. The storage module of claim 14, wherein the command to reset the value in the register can only be sent to the storage module after a correct password is provided.

24. The storage module of claim 14, wherein the register is in the memory.

25. The storage module of claim 24, wherein the value in the register is read from the memory and loaded to random access memory after a power cycle.

26. The storage module of claim 14, wherein the data is stored in single-level cells in the memory, and wherein the controller is further configured to move the data from the single-level cells in the memory to multi-level cells in the memory after the storage module has been soldered to a host device.
